(19) United States
(12) Patent Application Publication
(10) Pub. No.: US 2006/0246182 A1
(43) Pub. Date: Nov. 2, 2006

(54) Pizza having whole grain wheat flour crust and cooked at high temperature

(76) Inventors: Jessica Elizabeth McGovern, Naples, FL (US); Ryan John McGovern, Naples, FL (US)

Correspondence Address: Karl G. Hanson, 2000 Lost Horse Road, Medina, MN, 55340, US

(21) Appl. No.: 11/115,725

(22) Filed: Apr. 27, 2005

(51) Int. Cl. A21D 13/00

(52) U.S. Cl. 426/94

(57) ABSTRACT

A pizza 10 that includes a crust 12 and toppings 14. The crust 12 has first and second major surfaces 16 and 18 and contains whole-grain wheat flour, and toppings 14 are disposed on the first major surface 16 of the crust. The pizza 10 has been cooked in an oven 20, with the toppings 14 being disposed on the first major surface 16 of the crust 12 and with the second major surface 18 of the crust 12 being in contact with a cooking surface 24 of the oven at a temperature of at least about 500° F.

The present invention pertains to a pizza and to a method of making a pizza where the pizza crust contains whole grain wheat flour and where the pizza is cooked at a high temperature.

### BACKGROUND

In 1830 the world's first pizzeria was opened in Naples, Italy. The restaurant, Antica Pizzeria Port′ Alba is still in business today. Its pizzaiolo, Raffaele Esposito was invited to the Italian Royal Palace in 1889 to make a pizza for the King and Queen. Mr. Esposito—the Italian patriot that he was—presented King Umberto and Queen Margherita with three pizzas, one of which included ingredients that displayed the colors of the Italian flag: red, white, and green. Queen Margherita, no doubt a patriot herself, selected the pizza, which was made from tomato sauce (red), cheese (white), and basil (green) as her favorite. This classic pizza, which has forever become known as the Margherita, is sold today in many of the wonderful pizzerias throughout the world.

Not too long after the Margherita Pizza achieved its fame, the first pizzeria was opened in America in New York City. The large 19th-century influx of Italians from the old world to the new world made the opening of an American pizzeria nothing short of a sure thing. Thus in 1905, Gennaro Lombardi opened the first American pizzeria at 53½ Spring Street in lower Manhattan. Although closed in the early 1970's because it couldn't withstand a sustained attack from cheap fast food competition, Lombardi's reopened its doors a few years later in the mid seventies by the grandson of the founder, Gerry Lombardi. Despite this second attempt at commercial activity, Lombardi's closed again in the mid-eighties.

Lombardi made pizza according to the old world Neapolitan tradition started in Naples, Italy. The pizza was cooked at high temperatures in a coal-fired baker's oven. The ingredients were pure, the mozzarella was locally handmade, and the crust was of the baker' variety. When asked by New York Times writer Ed Levine if he would consider opening a pizzeria again, Gerry Lombardi replied “people don't know what that kind of pizza is anymore. The only know junk. They think pizza is junk food.” Ed Levine, Pizza: A Slice of Heaven, Universe Publishing, pp 87-97 (2005).

So what happened to the old world Neapolitan pizza that was fit for Kings and Queens? Why was it being relegated to the junk food bin?

Well . . . like so many other good things that came to America, the product became Americanized. It lost its purist origins; it became designed for mass production, to maximize profits of the commercial enterprises that sold it. Enterprises like Pizza Hut™ and Dominos™ sprang up across the nation. According to Levine, these entities tell you on their websites that they “all started as, first and foremost, a business proposition.” As such an enterprise, particularly when being a publicly traded corporation, its primary function is to maximize profits. Delivering a wholesome, healthy product becomes secondary, tertiary, or perhaps even not considered.

Take a careful look into the history of the flour industry, and you'll see a similar fact pattern. Before 1850, flour was predominantly made from “whole grains”. Wheat flour, for instance, commonly included the whole grain: the skin, the endosperm, and the germ (or seed of life). Mass production techniques, however, destroyed the “live”, healthy whole grain flour and turned it into a “dead” product that was only a fraction of its original self. Mildred E. Horton, Cooking with Wholegrains, North Point Press, pp 5-16 (1951, 1971).

White flour, which is commonly used in essentially every baked product that is made in America today, including pizza, does not contain many natural vitamins and other nutritional elements present in whole grains. So how did America go from flour products that were predominantly made from nutritional whole grains to the generally accepted use of bland white flour? Since Mildred Horton posed and answered this question in her book, Cooking with Whole Grains, the text of her essay is reproduced below in full without any editorialization or added emphasis:
Now when and why did the millers, already characterized as shrewd, begin to use less than all of the wheat berry which nature in its munificence furnish to mankind?
The story begins in the Stone Age when wheat berries were crushed or pounded between stones by the females of the tribe. After a few thousand years they learn to use saddle-stones, or one concave stone upon which the grain was spread and another stone to rub or grind the grain into a coarse or primitive meal. Even today in Mexico the saddle-stone, called the metata there, is used for grinding corn from which the Mexicans make their tortillas. The third and last of development of the stone was the quern or the stone rotation mill, the first complete milling machine. In existence as early as this second century B.C. this device was composed of two round French Buhr, or granite stones into which grooves were cut (the top turning on a stationary bottom stone), and it persisted down to about 75 years ago in England and America, and indeed is found in backcountry regions even today.
All these aforementioned processes obviously ground all of the kernel of corn, rye, oats, or wheat into meal, taking no part out in their forgiving real meaning to the word wholegrain. Then came the revolution.
About the middle of the 19th-Century when the industrial age was reaching out for more production in a mass-market, there was invented in developed (chiefly by Hungarians first and later by continental Europeans) the roller-mill. The first complete automatic roller-mill was established in the United Kingdom in 1878 at Dublin, although the principal had been introduced into Scotland as early as 1872.
The roller-mill, ancestor of the contemporary milling apparatus in practically all civilized countries, consist principally of fluted or grooved metal rollers. Unlike the single pair of cold stones turning slowly by water power, these rollers were arranged in a series, beginning with breakers to split the wheat, thus releasing the starch or endosperm so that it might be completely polarized and ground by the smoother reduction rollers into white flour we don't today. Naturally speed was the main objective. Such a system produced flour just about 100 times faster than the old slow-poke stone mills.
Yet the very slowness of the stone mill constituted its chief value as a food processing tool. The rich germ of the grain kernel has an oil that is susceptible to rancidity when heated in grinding, and if so heated clogs up the grinding services. But the cold stone mills turned slowly, anchor pulverized the germ into flour or meal. But like many another tool of earlier days, character quality soon became less important than speed, and so the stone mills gave way, about 1870 to another machine.
Now we come to the “mystery of the mill.” What else did the new high-speed steel roller-mill do except to grind grain 100 times faster? Well, the suit evident that the germ gummed up the high-speed rollers. Therefore, by series of graduated siftings it was possible to screen out this germ. This epoch-making discovery allowed the millers to expedite their operations, but more significant, they discovered soon enough that flour from which the live and perishable germ was screened out would keep indefinitely on store shelves.
It is rather appalling to realize how easily the milling trade has succeeded these many years on keeping these facts from the public, both in America and Great Britain. We only have to look at that famous authority, The Encyclopaedia Britannica, to obtain bonafide evidence. The erudite and technical account of milling in a compendium was written by an English miller, and it is revealing to see how nonchalantly he treats the process by which the germ was eliminated. He says, “ . . . in roller milling the germ was easily separated for the rest of the berry and it was readily sifted from the stock. The germ contains a good deal of fatty matter which, if allowed to remain, would not increase the keeping qualities of the flour.” (Italics added by Orton)
That such a standard reference should allow truth to be distorted is amazing enough, but not to the more sinister fact that the milling trade has now reached apotheosis of their craft when they believe their own lies and perpetuate them with no moral guilt whatever.
But it might be interesting to ask what is refined white flour that keeps better is doing to our stomachs. No one has summed it up more succinctly than Geoffrey Bowles and in that delightful magazine, the British Countrymen, when he declared, “Much about our national illness is caused by crazes for food that is (1) white, (2) refined, and (3) keepable. All three crazes are exemplified in white flour. The best food chemists are the earth and the sun, which produce the wholewheat that the steel rollers of the white flour millers spoil. White flour makes white faces . . . food is stuff to be eaten fresh, not to be ‘kept’ as if it were an heirloom . . . whole-meal flour naturally does not ‘keep’ because the germ in it is alive. Germless white flour ‘keeps’ because it is dead, because it is as dead as Portland cement powder, all of its original goodness having been sifted out of it. Let them ‘keep’ their flour who have no care to keep their health.”
   Today, obesity and diabetes have become national epidemics. It has been estimated that approximately 15% of all healthcare costs are associated with diabetes. In addition to lack of regular exercise, poor diets are mainly to blame. Following corporate America's lead, the general populace is stuffing their mouths with unhealthy, refined and processed foods day-after-day. White flour is just one example, but it is one most common ingredients in our foods. Adding to the problem, the grains too are grown on unhealthy soils, exposed annually to billions of pounds of poisons in the form of pesticides, herbicides, and synthetically made fertilizers. These chemicals, and the antibiotics that are fed to our factory raised cows and chickens, ultimately enter the environment, causing further damage to us in the areas where we live and recreate. The scale of human neglect to educate and care for a civil and healthy lifestyle goes far beyond Gerry Lombardi's comment on the consumer's seemingly ill-advised desire for garbage pizza.

Gerry Lombardi's frustration with the bastardization of pizza by corporate America notwithstanding, he did once again open Lombardi's pizza on Spring Street in Manhattan. According to Levine, Pizza is still made there according to the Neapolitan tradition. Many other Neapolitan style pizzerias exist on the East Coast, particularly in New York City. Many of these wonderful pizzerias are described in Levine's book cited above. Levine may very well have tasted more pizza than any other American, and he'll tell you that Neapolitan wood-fired pizza is the best. Neapolitan pizza also has made its way to places like Minnesota where John Sorrano has now his opened his third pizzeria under the “Punch” label. Neapolitan pizzerias typically operate under the Vera Pizza Napoletana (VPN) standards, which involve oven temperatures upwards of 750 to 800° F. At such temperatures, the pizza is rapidly cooked (usually about 80 to 120 seconds to bake), locking in the flavors of the toppings and making the crust blister but pliable. The known Neapolitan style pizzerias, as well as the many chain pizza restaurants—despite there being legions—all use white flour when making the pizza crust.

### SUMMARY OF THE INVENTION

The present invention provides a pizza that comprises: (a) a crust that has first and second major surfaces and that contains whole grain wheat flour; and (b) toppings disposed on the first major surface of the crust. The pizza has been cooked in an oven, with the toppings being disposed on the first major surface of the crust and with the second major surface of the crust being in contact with a cooking surface of the oven at a temperature of at least about 500 degrees Fahrenheit (° F.).

The present invention also provides a new method of making a pizza, which method comprises:

(a) rolling and shaping a dough that contains whole grain wheat flour into a pre-crust that has first and second major surfaces;

(b) placing toppings onto the first major surface of the pre-crust;

(c) placing the pre-crust, with the toppings on the first major surface, in an oven that is capable of maintaining an oven temperature exceeding 600° F., the pizza being placed in the oven such that the second major surface of the pizza is in contact with a cooking surface of the oven; then

(d) cooking the pre-crust with the toppings thereon in the oven at a cooking surface temperature of at least about 500° F. to provide a pizza that has a crust and cooked toppings thereon; and then

(e) removing the pizza from the oven.

The present invention differs from known pizzas and methods of making pizzas in that the pizza uses a crust that contains whole grain wheat flour and in that the pizza is cooked at a very high temperature. Pizzas that have been made previously did not use whole grain wheat flour in the crust. Although the Neapolitan style pizzas have been cooked at high temperatures for decades, these pizzas have commonly been made using a white flour. Since white flour does not use all grain parts and is essentially “dead”, it would be expected that it could withstand high cooking temperatures. What the inventors of this application discovered is that a wheat-flour-containing-crust could be cooked at high temperatures to give extraordinary results. Given the “live” nature of the whole grain, there was uncertainty regarding how the pizza crust would turn out. Because so much of the taste of a pizza is governed by the taste of the crust, a bad tasting crust would no doubt produce a bad product. But shortly after the inventors opened a restaurant, which brought the Naples, Italy Neapolitan style pizza to Naples, Fla., persons who dined at their establishment, the “Pizza and Coconut Café” had great things to say about the new pizza that had a whole-grain wheat flour crust cooked at high heat. A gentleman from Boston, Mass. who dined at the restaurant described it as “the best pizza in the world”. A local female resident expressed “your pizza is a work of art. It's fantastic, delectable, delicious!” Customers have indicated that the pizza crust doesn't seem to “sit in your stomach and give you a ‘heavy feeling”’. The food editor of the Naples Daily News remarked “[t]he dull sounding wheat crust, paper-thin and full-flavored—cooked in the Cafe's wood-burning oven at 650 degrees—proved to be about the best crust in town.” Naples Daily News, Dining Out: Organic Fare with Flair to Spare at Pizza & Coconut Cafe (Dec. 10, 2004). Another resident of Naples, Fla. said the following: “I have had pizza from Connecticut to California, from Chicago to Dallas, and all over the world. Pizza and Coconut is the best pizza on the face of the Earth.” Even a man from Rome, Italy who tried the pizza said “this is the best pizza in the world.”

The above and other benefits of the invention are more fully shown and described in the drawings and detailed description of this invention, where like reference numerals are used to represent similar parts. It is to be understood, however, that the drawings and description are for illustration purposes of only and should not be read in a manner that unduly limits the scope of the invention.

### Glossary

The terms used in this application will have the following meanings:

“cooking surface” means the surface onto which the pizza rests while being baked in the oven;

“crust” means the portion of the pizza that comprises cooked pizza dough;

“flour” means grain that has been processed (ground) into a generally uniform dusty type mixture;

“pizza” means pizza in its conventional sense and means only those products that are described as “pizza” in the commercial setting (this definition does not include flat breads);

“thin crust” means a pizza crust that before cooking (i.e. pre-crust) has an average thickness no greater than about ¾ of an inch;

“toppings” mean any edible item that is placed on the top side of a pizza;

“top side” means the side or major surface of the pizza opposite the side that makes contact with the cooking surface of the oven when the pizza is being cooked;

“whole grain” means that the grain includes the skin, the endosperm, and the germ;

“wood burning oven” means an oven that uses at least wood or other wood based product, for example, charcoal, as a means for providing heat to the oven;

### BRIEF DESCRIPTION OF THE DRAWINGS

FIG. 1 is a perspective view of a pizza 10 in accordance with the present invention;

FIG. 2 is a perspective view of a wood burning oven 20 that can be used to make pizza in accordance with the present invention; and

FIG. 3 is a flow diagram that illustrates a method of making a pizza in accordance with the present invention.

### DETAILED DESCRIPTION OF PREFERRED EMBODIMENTS

In describing preferred embodiments of the invention, specific terminology is used for the sake of clarity. The invention, however, is not intended to be limited to the specific terms so selected, and it is to be understood that each term so selected includes all technical equivalents that operate similarly.

In the practice of the present invention, a new pizza and method of making a pizza are provided, which pizza and method provide pizza eaters with a product having extraordinarily great taste. The inventive pizza is indeed a food that does not leave you feeling full and bloated but rather leaves you feeling content and light. When compared to white flour based pizzas, which seem to give the eater the sense that a ball of dough is sitting in their stomach, the crust of the present invention is more-or-less unnoticeable or undistinguishable from the other consumed contents of the pizza when in the stomach. The eater also notices a better taste when the pizza is in their mouths. The crust is not bland like crust made from white dough. There is a more complete taste to the product. It is easily chewable and not excessively doughy. The crust also is easy to handle. It is not flimsy or soggy; it can be consumed without utensils and without the toppings falling off it when eating with the hands. The crust is firm but not brittle. It can be bent over upon itself and eaten like a sandwich according to the Italian style.

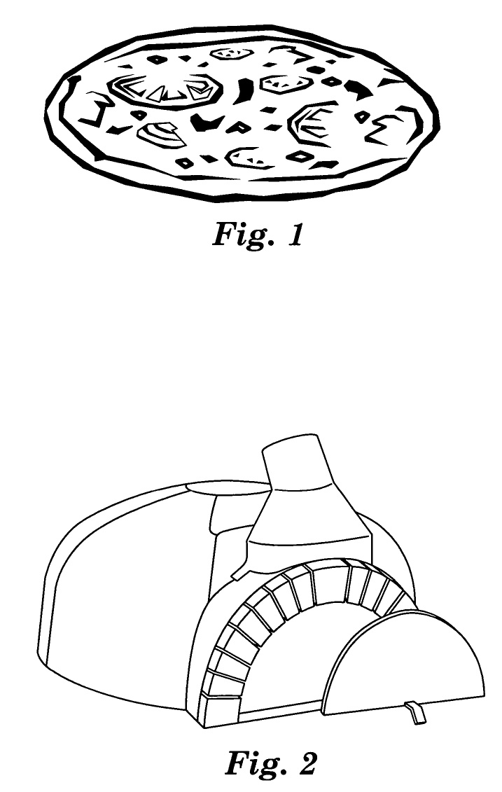

FIG. 1 shows a pizza 10 that comprises a crust 12 and toppings 14. The crust 12 contains whole grain wheat flour and has first and second major surfaces, 16 and 18, respectively. The toppings 14 are disposed on the first major surface 16 of the crust 12. The second major surface 18 defines the bottom of the pizza, and it resides in contact with the cooking surface of the oven when being cooked. The pizza crust preferably is made from a dough that contains at least about 25% whole-grain wheat flour based on the total volume of flour in the dough. More preferably there is at least about 50% whole-grain wheat flour in the dough used to make the crust, and still more preferably at least about 75% whole-grain wheat flour. In a yet more preferred embodiment, the dough consists essentially of all whole-grain wheat flour based on the total volume of flour used to make the crust.

FIG. 2 shows a wood burning pizza oven 20 that has an opening 22 for placing pizzas in the oven interior. The oven also has a floor or cooking surface 24 and a top or domed portion 26. The opening 22 also allows fuel to be added to the oven. The fuel, such as dried wood, is added to the oven interior and is ignited to heat the oven. When starting the fire, the wood (or for example, charcoal) is ignited with, for example, newspaper or starter fluid and is allowed to burn until a good-sized flame is created. Additional wood may be added to the oven and the flame is allowed to expand until the oven reaches approximately 1000 degrees Fahrenheit (° F.). Heating the oven to this high a temperature allows any carbon that may have been deposited on the oven interior from a prior use to be burnt off. Excess heat and exhaust from the burning process leaves the oven interior through chimney 28. Once this process is complete, the wood may be pushed off to one side of the oven where it is allowed to burn at a rate that keeps the oven at the desired temperature. The cooking surface of the oven may be brushed so that ash from the initial starting process does not reside in the area where the pizza is cooked. Usually, the pizza is cooked towards the center of the oven, and the burning wood is placed off to the side. The oven temperature generally is at least about 500° F. to about 850° F. during cooking. To accommodate such temperatures, the oven is typically lined with a ceramic material such as brick or stone 29. Bricks made from refractory cotto have proven to give good results. In addition to wood, the oven also could be fired with burning gas such as methane or propane. The oven preferably is heated solely with wood to give added flavor to the pizza. A commercially available wood-burning pizza oven is available from Mugnaini Imports, LLC, Watsonville, Calif.

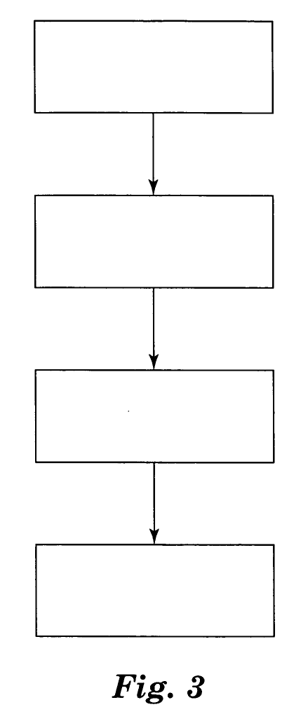

FIG. 3 illustrates method steps that may be used to make a pizza according to the inventive method. To make a pizza using the present invention, the pizza chef or pizzaiolo first makes the dough. This also could be done off-site, but preferably is made fresh on site on the day the pizza is cooked or a day or so earlier. The dough is made by combining the whole grain wheat flour, water, yeast, and salt. The flour to water ratio is preferably about or slightly greater than 2:1 by volume, preferably 16:7. To this mixture are included small amounts of salt and yeast. Generally about or slightly greater than 2 parts salt to about 1 part yeast, preferably 8 parts salt to 3.5 parts yeast by volume, are used. The pizzaiolo then rolls and shapes the dough that contains whole grain wheat flour, water, salt and yeast into a ball that is allowed to rise until the dough approximately doubles in size, commonly for at least 1 hour, preferably about 1.25 to 3 hours, more preferably about 1.5 hours. The dough is then cut into individual portions that are sized to make an individual pizza pre-crust. These cut portions are allowed to further rise, typically for about 0.5 to 2.5 hours, more typically for about 1 hour. The rising times may vary, depending on environmental conditions. The dough portions are rolled into a flat pre-crust that typically is less than about ½ inches thick (more typically about ⅛ to ¼ inch thick), that is circular in shape, and that has first and second major surfaces. The pizzaiolo then places toppings onto the first major surface of the pre-crust. Sauces like tomato sauces and barbeque sauce are usually placed on the crust first. Other toppings include cheeses like mozzarella, Romano, parmesan (such as parmesan-reggiano), and feta. The chef may also add fresh vegetables and fruits like spinach, olives, capers, broccoli, pineapple, tomatoes, and onions. Herbs like basil, fennel, oregano, and rosemary may also used as toppings, as well as fungi such as mushrooms. Meats (like sausage, pepperoni, and chicken), fish, mollusks and clams, and anchovies also may be applied. All toppings are preferably USDA organic. The pre-crust, with the desired toppings on the first major surface, is then placed in an oven that is capable of maintaining an oven temperature exceeding 600° F. The oven temperature can be measured using a culinary laser thermometer. The laser beam is pointed centrally at the back of the oven to get the general oven temperature. The cooking surface temperature is measured by pointing the laser on the cooking surface where the pizza is baked. The pizza is placed in the oven such that the second major surface of the pizza is in contact with a cooking surface of the oven. Then the pre-crust is cooked with the toppings in the oven at temperature of at least about 500° F. to about 850° F. to provide a pizza that has a crust and cooked toppings thereon. When cooking a pizza dough that contains whole wheat flour, the inventor discovered that it is best to have the cooking surface at about 590 to about 650° F., preferably about 600 to about 630° F. When the cooking surface is at this temperature, the side of the oven away from the fire is about 550° F. while the top dome is about 700° F. With the cooking surface at this temperature, the total pizza baking or cooking time is about 2.5 to 5 minutes, more typically about 3 to 4.5 minutes. Common Neapolitan pizzas are generally cooked at higher temperatures because the white flour can withstand higher temperatures better. Whole grain wheat flour tends to excessively char when the cooking surface exceeds 700° F. for a good portion (>about 1 minute) of the cooking time. Once the pizza crust starts to turn color (becomes dark brown) on the surface, the pizzaiolo then removes the pizza from the oven.

The following Examples have been selected merely to further illustrate features, advantages, and other details of the invention. It is to be expressly understood, however, that while the Examples serve this purpose, the particular ingredients and amounts used as well as other conditions and details are not to be construed in a manner that would unduly limit the scope of this invention.

### EXAMPLE

In making the dough, the following ingredients are used:

(a) 16 cups of stone-ground, organic, whole-grain wheat flour from the white winterberry;

(b) 8 teaspoons natural sea salt;

(c) 3.5 teaspoons instant SAF yeast; and

(d) 7 cups warm bottled spring water.

Sixteen measured cups of the flour are placed into a large bowl. Add salt and yeast to the mixture and stir thoroughly. Warm the water on stove to approximately 100° F. Mix slowly into the flour mixture until it all comes together. Then with your hands, start to form a ball. Knead the dough for 10 minutes until soft and elastic.

Lightly coat a large bowl with one tablespoon of organic Italian extra virgin olive oil. Place dough ball inside the bowl, turning it to cover with the oil. Cover with a lid and let it rise until it approximately doubles in size, about 1.5 hours.

Flatten the dough with your hands. Then start to portion out each individual pizza dough. Weigh out 9 ounces of dough and shape into balls, keeping the seam of dough on the bottom and making approximately 16 individual dough portions. Put the individual dough portions in a container without stacking. Lightly oil the top of each dough portion and cover the container. Allow the dough to rise again about one hour. The rising times may vary according to the temperature and humidity in the kitchen. After the second rising of the dough, the dough is ready to use to prepare a pizza pre-crust for a pizza.

Using a roller, flatten the dough portion into a round pizza about ⅛ to ⅜ inches thick (preferably about ¼ inch) and about 6 to about 14 inches in diameter. Place the desired toppings on the pizza and place the pizza in a wood-burning oven that has a cooking surface temperature of preferably about 620° F. The cooking surface is preferably brushed clean before the pizza is placed on it. The oven may be a Valoriani pizza oven made and sold by Mugnaini Imports, LLC, Watsonville, Calif. This oven includes a flue manifold, refractory mortar or terra cotta and Kaowool insulation. The cooking surface preferably has sufficient porosity to allow moisture to escape. The alumina content preferably is less than 40%. The oven has a curved interior wall to facilitate convention airflow. Let the pizza cook about 3 minutes, using a spatula to rotate the pizza about 180° F. at the baking mid-point so that it is equally cooked on all sides. Remove the pizza from the oven, slice as desired, let cool, and eat.

This invention may take on various modifications and alterations without departing from its spirit and scope. Accordingly, the invention is not to be limited to the above-described but is to be controlled by the limitations set forth in the following claims and any equivalents thereof.

This invention also may be suitably practiced in the absence of any element not specifically disclosed in this document.

All patents and patent applications cited above, including those in the Background section, are incorporated by reference into this document in total.

What is claimed is:

1. A pizza that comprises:
(a) a crust that has first and second major surfaces and that contains whole grain wheat flour; and
(b) toppings disposed on the first major surface of the crust;
wherein the pizza has been cooked in an oven, with the toppings being disposed on the first major surface of the crust and with the second major surface of the crust being in contact with a cooking surface of the oven at a temperature of at least about 500° F.

2. The pizza of claim 1, wherein pizza has been cooked on a cooking surface that is at about 590 to about 650° F.

3. The pizza of claim 2, wherein pizza has been cooked at about 600 to about 630° F.

4. The pizza of claim 1, wherein the crust contains at least about 25% whole grain wheat flour based on the volume of the flour.

5. The pizza of claim 4, wherein the crust contains at least about 50% whole grain wheat flour based on the volume of the flour.

6. The pizza of claim 5, wherein the crust contains at least about 75% whole grain wheat flour based on the volume of the flour.

7. The pizza of claim 6, wherein the crust consists essentially of all whole grain wheat flour based on the volume of the flour.

8. The pizza of claim 6, wherein the crust contains about 100% whole grain wheat flour based on the volume of the flour.

9. The pizza of claim 1, wherein the crust, with the exception of raised blister areas, is less than ½ inch thick and wherein the toppings include organic ingredients.

10. A pizza that comprises:
(a) a crust that has first and second major surfaces and that contains at least about 50% whole grain wheat flour based on the volume of the flour; and
(b) toppings disposed on the first major surface of the crust;
wherein the pizza has been cooked in wood-fired oven that is lined at least in part of stones or bricks, with the toppings disposed on the first major surface of the crust and with the second major surface of the crust being in contact with a cooking surface of the oven at a cooking surface temperature of at least about 590° F.

10. The pizza of claim 11 wherein the crust has raised blisters thereon and can be bent from a first planar condition to a second bent condition such that the first major surface contacts itself and such that the crust does not break.

11. A method of making a pizza, which method comprises:
(a) rolling and shaping a dough that contains whole grain wheat flour into a pre-crust that has first and second major surfaces;
(b) placing toppings onto the first major surface of the pre-crust;
(c) placing the pre-crust, with the toppings on the first major surface, in an oven that is capable of maintaining an oven temperature exceeding 600° F., the pizza being placed in the oven such that the second major surface of the pizza is in contact with a cooking surface of the oven; then
(d) cooking the pre-crust with the toppings thereon in the oven on a cooking surface that is at a temperature of at least about 500° F. to provide a pizza that has a crust and cooked toppings thereon; and then
(e) removing the pizza from the oven.

12. The method of claim 11, wherein the oven is capable of maintaining a temperature at least above 625° F., and wherein the cooking step is carried out with the cooking surface being about 590° F. to about 650° F.

13. The method of claim 12, wherein the cooking surface and an oven top are lined at least in part with bricks or stones, and wherein the cooking step is carried out with the oven temperature being about 600° F. to about 630° F.

14. The method of claim 13, wherein the oven is a wood-fired oven.

15. The method of claim 14, wherein the pre-crust is less than ½ inch thick.

16. The method of claim 11, wherein the oven is lined at least in part with a ceramic material.

17. The pizza of claim 16, wherein the oven is lined at least in part with bricks or stones.

18. The pizza of claim 17, wherein the oven is a wood-fired oven.
